(19) United States
(12) Patent Application Publication
(10) Pub. No.: US 2005/0042150 A1
(43) Pub. Date: Feb. 24, 2005

(54) Apparatus and method for the production of hydrogen

(76) Inventor: Linnard Griffin, Bertram, TX (US)

Correspondence Address: STORM & HEMINGWAY, L.L.P., 8117 PRESTON RD., STE. 460, DALLAS, TX, 75225, US

(21) Appl. No.: 10/919,755

(22) Filed: Aug. 17, 2004

Related U.S. Application Data
(60) Provisional application No. 60/496,174, filed on Aug. 19, 2003.
(60) Provisional application No. 60/508,989, filed on Oct. 6, 2003.
(60) Provisional application No. 60/512,663, filed on Oct. 20, 2003.
(60) Provisional application No. 60/524,468, filed on Nov. 24, 2003.
(60) Provisional application No. 60/531,766, filed on Dec. 22, 2003.
(60) Provisional application No. 60/531,767, filed on Dec. 22, 2003.

(51) Int. Cl. B32B 5/02

(52) U.S. Cl. 422/139

(57) ABSTRACT

An apparatus and method for the production of hydrogen comprising a solution with a pH less than 7, at least one colloidal metal suspended in the solution, and a non-colloidal metal.

### RELATED APPLICATION

This application claims priority to provisional application Ser. No. 60/496,174, filed Aug. 19, 2003.

### TECHNICAL FIELD

The present invention is directed to a method and apparatus for the production of hydrogen gas from water.

### BACKGROUND

Hydrogen gas is a valuable commodity with many current and potential uses. Hydrogen gas may be produced by a chemical reaction between water and a metal or metallic compound. Very reactive metals react with mineral acids to produce a salt plus hydrogen gas. Equations 1 through 5 are examples of this process, where HX represents any mineral acid. HX can represent, for example HCl, HBr, HI, H₂SO₄, HNO₃, but includes all acids.
2Li+2HX→H₂+2LiX (1)
2K+2HX→H₂+2KX (2)
2Na+2HX→H₂+2NaX (3)
Ca+2HX→H₂+CaX₂ (4)
Mg+2HX→H₂+MgX₂ (5)

Each of these reactions take place at an extremely high rate due to the very high activity of lithium, potassium, sodium, calcium, and magnesium, which are listed in order of their respective reaction rates, with lithium reacting the fastest and magnesium reacting the most slowly of this group of metals. In fact, these reactions take place at such an accelerated rate that they have not been considered to provide a useful method for the synthesis of hydrogen gas in the prior art.

Metals of intermediate reactivity undergo the same reaction but at a much more controllable reaction rate. Equations 6 and 7 are examples, again where HX represents all mineral acids.
Zn+2HX→H₂+ZnX₂ (6)
2Al+6HX→3H₂+2AlX₃ (7)

Reactions of this type provide a better method for the production of hydrogen gas due to their relatively slower and therefore more controllable reaction rate. Metals like these have not, however, been used in prior art production of diatomic hydrogen because of the expense of these metals.

Iron reacts with mineral acids by either of the following equations:
Fe+2HX→H₂+FeX₂ (8)
or
   2Fe+6HX→3H₂+2FeX₃ (9)

Due to the rather low activity of iron, both of these reactions take place at a rather slow reaction rate. The reaction rates are so slow that these reactions have not been considered to provide a useful method for the production of diatomic hydrogen in the prior art. Thus, while iron does provide the availability and low price needed for the production of elemental hydrogen, it does not react at a rate great enough to make it useful for hydrogen production.

Metals such as silver, gold, and platinum are not found to undergo reaction with mineral acids under normal conditions in the prior art.
Ag+HX→No Reaction (10)
Au+HX→No Reaction (11)
Pt+HX→No Reaction (12)

Accordingly, there exist a need for a method and apparatus for the efficient production of hydrogen gas using relatively inexpensive metals.

### SUMMARY

Described herein is an apparatus for the production of hydrogen comprising a solution with a pH less than 7, at least one colloidal metal suspended in the solution, and an ionic metal.

Another embodiment of the invention described herein provides an apparatus for the production of hydrogen, comprising a solution with a pH less than 7, at least one colloidal metal suspended in the solution, and a non-colloidal metal.

### BRIEF DESCRIPTION OF THE DRAWINGS

FIG. 1 is a diagram of a reactor for the production of hydrogen.

FIG. 2 is a diagram of a laboratory experiment set-up.

### DETAILED DESCRIPTION

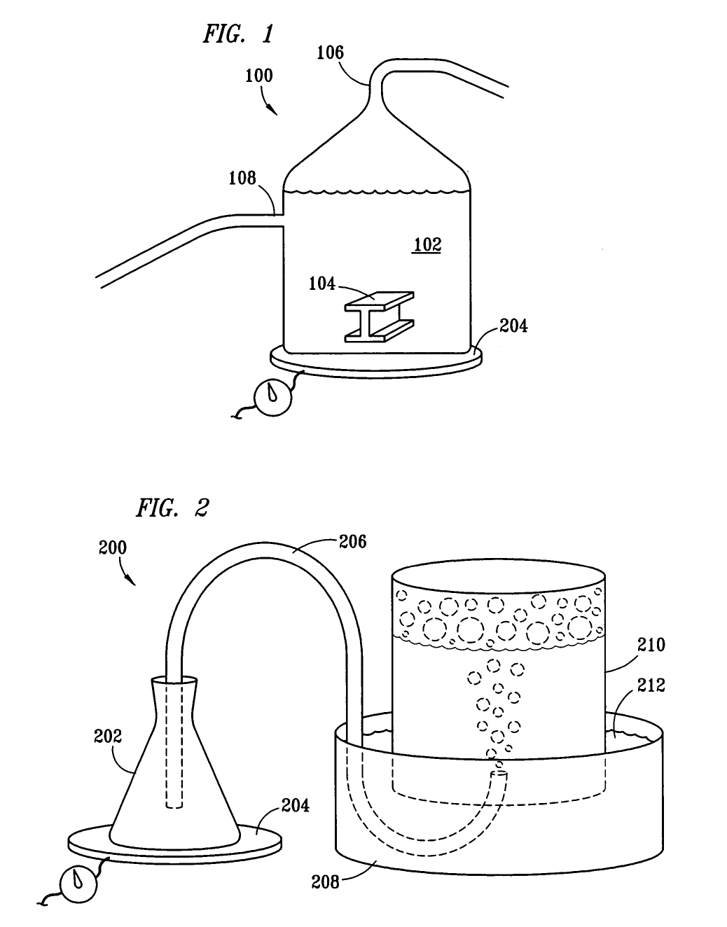

FIG. 1 shows an apparatus that may be used for the production of hydrogen. A reaction vessel 100 contains a solution 102 comprising water and an acid, the solution having a pH less than 7 and preferably less than 5. The acid is preferably sulfuric acid or hydrochloric acid, although other acids may be used. The reaction vessel 100 is inert to the solution 102. The solution 102 contains a first colloidal metal (not shown) suspended in the solution. The first colloidal metal is preferably a metal with low activity such as silver, gold, platinum, tin, lead, copper, zinc or cadmium, although other metals may be used. The reaction vessel 102 also preferably contains a non-colloidal metal 104, at least partially submerged in the solution 102. The non-colloidal metal may be in any form but is preferably in the form of a solid with a relatively large surface area, such as pellet form. The non-colloidal metal 104 is preferably a metal with a mid-range activity, such as iron, zinc, nickel or tin. The non-colloidal metal 104 preferably has a higher activity than the first colloidal metal. The non-colloidal metal 104 is most preferably iron, because of its medium reactivity and low cost. Preferably, the solution 102 also contains a second colloidal metal (not shown). The second colloidal metal preferably has a higher activity than the non-colloidal metal 104, such as aluminum, magnesium, beryllium, and lithium.

Alternatively to the above, the solution 102 may contain a metal salt or metal oxide, rather than an acid and the non-colloidal metal 104, in addition to the one or more colloidal metals. Preferably, the solution 102 contains a solid metal and either an acid or a metal salt or metal oxide of the same metal as the solid metal 104. It is believed that if the solution 102 initially contains a solid metal and a strong acid, such as HCl or H₂SO₄, the acid reacts with the solid metal, creating metal ions and releasing hydrogen gas, until the acid or solid metal is substantially consumed. It is also believed that a solution initially containing a metal salt along with a proper colloidal catalyst will become acidic, even if the initial pH is greater than 7.

The reaction vessel 100 has an outlet 106 to allow hydrogen gas (not shown) to escape. The reaction vessel may also have an inlet 108 for adding water or other constituents to maintain the proper concentrations.

Because the reactions expected to occur in the reaction vessel are believed to be collectively endothermic, an energy source 112 is also preferably provided to increase the rate of reaction, although the reaction may potentially be powered by ambient heat. While the energy source shown in FIG. 1 is a heater (hot plate), other forms of energy may be used including electric and light energy. There may be other effects of light or other electromagnetic radiation, in addition to the energy effect, which are not yet fully understood.

Most metals can be produced in a colloidal state in an aqueous solution. A colloid is a material composed of very small particles of one substance that are dispersed (suspended), but not dissolved in solution. Thus colloidal particles do not settle out of solution even though they exist in the solid state. A colloid of any particular metal is then a very small particle of that metal suspended in a solution. These suspended particles of metal may exist in the solid (metallic) form or in the ionic form, or as a mixture of the two. The very small size of the particles of these metals results in a very large effective surface area for the metal. This very large effective surface area for the metal can cause the surface reactions of the metal to increase dramatically when it comes into contact with other atoms or molecules. The colloidal metals used in the experiments described below were obtained using a colloidal silver machine sold by CS Prosystems of San Antonio, Tex. The website of CS Prosystems is www.csprosystems.com. Based on materials from the manufacturer, the particles of a metal in the colloidal solutions used in the experiments described below are believed to range in size between 0.001 and 0.01 microns. In such a solution of colloidal metals, the concentrations of the metals is believed to be between about 5 to 20 parts per million.

Alternative to using a catalyst in colloidal form, it may be possible to use a catalyst in another form that offers a high surface-area to volume ratio, such as a porous solid or colloid-polymer nanocomposites. In general, any the catalysts may be in any form with an effective surface area of at least 298,000,000 m² per cubic meter of catalyst metal, although smaller surface area ratios may also work.

Thus when any metal, regardless of its normal reactivity, is used in its colloidal form, the reaction of the metal with mineral acids can take place at an accelerated rate. Equations 13-15 are thus general equations that are believed to occur for any metals in spite of their normal reactivity, where M represents any metal. M, for instance, can represent but is not limited to silver, copper, tin, zinc, lead, and cadmium. In fact, it has been found that the reactions shown in equations 13-15 occur at a significant reaction rate even in solutions of 1% aqueous acid.
2M+2HX→2MX+H₂ (13)
M+2HX→MX₂+H₂ (14)
2M+6HX→2MX₃+3H₂ (15)

Even though equations 13-15 represent largely endothermic processes for a great many metals, particularly those of traditional low reactivity (for example but not limited to silver, gold, copper, tin, lead, and zinc), the rate of the reactions depicted in equations 13-15 is in fact very large due to the surface effects caused by the use of the colloidal metal. While reactions involved with equations 13-15 take place at a highly accelerated reaction rate, these reactions do not result in a useful production of elemental hydrogen since the colloidal metal by definition is present in very, very low concentrations.

A useful preparation of hydrogen results however by the inclusion of a metal more reactive than the colloidal metal such as but not limited to metallic iron. Thus any colloidal metal in its ionic form would be expected to react with metallic iron as indicated in equations 16-18, where those metals below iron on the electromotive or activity series of metals (cadmium and below) would react best.
Fe+2M⁺→2M+Fe⁺² (16)
Fe+M⁺²→M+Fe⁺² (17)
3Fe+2M⁺³→2M+3Fe⁺² (18)

It is believed that the reactions illustrated by equations 16-18 in fact take place quite readily due to the large effective surface area of the colloidal ion, M⁺ⁿ, and also due to the greater reactivity of iron compared to any metal of lower reactivity which would be of preferable use. In fact, for metals normally lower in reactivity than iron, equations 16-18 would result in highly exothermic reactions. The resulting metal, M, would be present in colloidal quantities and thus, it is believed, undergoes a facile reaction with any mineral acid including, but not limited to, sulfuric acid, hydrochloric acid, hydrobromic acid, nitric acid, hydroiodic acid, perchloric acid, and chloric acid. However, the mineral acid is preferably sulfuric acid, H₂SO₄, or hydrochloric acid, HCl. Equations 19-21 describe this reaction where the formula HX (or H⁺+X⁻ in its ionic form) is a general representation for any mineral acid.
2M+2H⁺+2X⁻→2M⁺¹+H₂+2X⁻ (19)
M+2H⁺+2X⁻→M⁺²+H₂+2X⁻ (20)
2M+6H⁺+6X⁻→2M⁺³+3H₂+6X⁻ (21)

While equations 19-21 represent endothermic reactions, it is believed the exothermicity of the reactions in equations 16-18 compensate for this, making the combination of the two reactions thermally obtainable using the thermal energy supplied by ambient conditions. Of course the supply of additional energy would accelerate the process.

Consequently, it is believed that elemental hydrogen is efficiently and easily produced by the combination of the reactions shown in equations 22 and 23.
2Fe+4M⁺→4M+2Fe⁺² (22)
4M+4H⁺+4X⁻→4M⁺¹+2H₂+4X⁻ (23)

Thus iron reacts with the colloidal metal ion in equation 22 to produce a colloidal metal and ionic iron. The colloidal metal will then react with a mineral acid in equation 23 to produce elemental hydrogen and regenerate the colloidal metal ion. The colloidal metal ion will then react again by equation 22, followed again by equation 23, and so on in a chain reaction process to provide an efficient source of elemental hydrogen. In principle, any colloidal metal ion should undergo this process successfully. It is found that the reactions work most efficiently when the colloidal metal ion is lower in reactivity than iron (or other solid metal used) on the electromotive series table. The combining of equations 22 and 23, results in the net equation 24. Equation 24 has as its result the production of elemental hydrogen from the reaction of iron and a mineral acid.

$$\begin{matrix}\begin{matrix}2 Fe + 4 {M}^{+} \to 4 M + 2 {Fe}^{+ 2} \\ +\end{matrix} & ( 22 ) \\ \begin{matrix}4 M + 4 {H}^{+} + 4 {X}^{-} \to 4 {M}^{+ 1} + 2 {H}_{2} + 4 {X}^{-} \\ =\end{matrix} & ( 23 ) \\ 2 Fe + 4 {H}^{+} \to 2 {Fe}^{+ 2} + 2 {H}_{2} & ( 24 )\end{matrix}$$

Equation 24 summarizes a process that provides a very efficient production of elemental hydrogen where elemental iron and acid are consumed. It is believed, however that both the elemental iron and the acid are regenerated as a result of a voltaic electrochemical process or thermal process that follows. It is believed that a colloidal metal Mᵣ (which can be the same one used in equation 22 or a different one), can undergo a voltaic oxidation—reduction reaction indicated by equations 25, and 26.

### Cathode (Reduction)

4Mᵣ⁺+4e⁻→4Mᵣ (25)

### Anode (Oxidation)

2H₂O→4H⁺+O₂+4e⁻ (26)

The colloidal metal Mᵣ can in principle be any metal but reaction 25 progresses most efficiently when the metal has a higher (more positive) reduction potential. Thus, the reduction of the colloidal metal ion, as indicated in equation 25, takes place most efficiently when the colloidal metal is lower than iron on the electromotive series of metals. Consequently, any colloidal metal will be successful, but reaction 25 works best with colloidal silver or lead, due to the high reduction potential of these metals. When lead, for example, is employed as the colloidal metal ion in equations 25 and 26, the pair of reactions is found to take place quite readily. The voltaic reaction produces a positive voltage as the oxidation and reduction reactions indicated take place. This positive voltage can be used to supply the energy required for other chemical processes. In fact the voltage produced can even be used to supply an over potential for reactions employing equations 25 and 26 taking place in another reaction vessel. Thus this electrochemical process can be made to take place more quickly without the supply of an external source of energy. The resulting colloidal metal, Mᵣ, can then react with oxidized ionic iron (or other solid metal, preferably with a lower activity than the colloidal metal) (equation 27) which would result in the regeneration of the metallic iron (or other metal), and the regeneration of the colloidal metal in its oxidized form.
2Fe⁺²+4Mᵣ→4Mᵣ⁺+2Fe (27)

The reaction described by equation 27 could in fact occur using as starting material any colloidal metal, but will take place most effectively when the colloidal metal, Mᵣ, appears above iron on the electromotive series. The combining of equations 25-27 results in equation 28 which represents the regeneration of the elemental iron, the regeneration of the acid, and the formation of elemental oxygen.

$$\begin{matrix}\begin{matrix}4 {M}_{r}^{-} + 4 {e}^{-} \to 4 {M}_{r} \\ +\end{matrix} & ( 25 ) \\ \begin{matrix}2 {H}_{2} O \to 4 {H}^{+} + {O}_{2} + 4 {e}^{-} \\ +\end{matrix} & ( 26 ) \\ \begin{matrix}2 {Fe}^{+ 2} + 4 {M}_{r} \to 4 {M}_{r}^{+} + 2 Fe \\ =\end{matrix} & ( 27 ) \\ 2 {Fe}^{+ 2} + 2 {H}_{2} O \to 4 {H}^{+} + 2 Fe + {O}_{2} & ( 28 )\end{matrix}$$

The combination of equations 24 and 28 results in a net process indicated in equation 29. As discussed above, the reaction depicted in equation 25 proceeds most efficiently when the colloidal metal is found below iron in the electromotive series. However, the reaction represented by equation 27 is most favorable when the colloidal metal is found above iron in the electromotive series. Accordingly, it has been observed that the concurrent use of two colloidal metals, one above iron and one below iron in the electromotive series, for example, but not limited to, colloidal lead and colloidal aluminum, produces optimum results in terms of the efficiency of the net process. Since equation 29 merely depicts the decomposition of water into elemental hydrogen and elemental Oxygen, the complete process for the production of elemental hydrogen now has only water as an expendable substance, and the only necessary energy source is supplied by ambient thermal conditions.

$$\begin{matrix}\begin{matrix}2 Fe + 4 {H}^{+} \to 2 {Fe}^{+ 2} + 2 {H}_{2} \\ +\end{matrix} & ( 24 ) \\ \begin{matrix}2 {Fe}^{+ 2} + 2 {H}_{2} O \to 4 {H}^{+} + 2 Fe + {O}_{2} \\ =\end{matrix} & ( 28 ) \\ 2 {H}_{2} O \to 2 {H}_{2} + {O}_{2} & ( 29 )\end{matrix}$$

The net result of this process is exactly that which would result from the electrolysis of water. Here, however, no electrical energy needs to be supplied. Although additional energy is helpful, the reaction proceeds when the only energy supplied is ambient thermal energy. The colloidal metallic ion catalysts, as well as the metallic iron (or other metal), and the acid are regenerated in the process, leaving only water as a consumable material.

Experimental Results:

Experiment #1:

An initial solution comprising 10 mL of 93% concentration H₂SO₄ and 30 mL of 35% concentration HCl was reacted with iron pellets (sponge iron) and about 50 ml of colloidal magnesium and 80 ml of colloidal lead each at a concentration believed to be about 20 ppm. A theoretical maximum of 8.06 liters of hydrogen gas could be produced if solely from the consumption of the acids as indicated in Table 1.

TABLE 1
Starting Solution Maximum H₂ Yield
with Acid Consumption

| | | | | Effective | Maximum H₂ |
|---|---|---|---|---|---|
| Acid | mL | Concentration | Total Gr. | Gr. of Acid | Yield |
| H₂SO₄ | 10 | 93.0% | 18.97 | 17.64 | 4.03 liters |
| HCl | 30 | 35.0% | 37.52 | 13.13 | 4.03 liters |

| | |
|---|---|
| Maximum H₂ Yield: | 8.06 liters |

1 mole H₂SO₄ yields 1 mole H₂ (22.4 liters)
1 mole H₂SO₄₌₉₈ grams

Therefore, maximum yield of 0.23 liters of H₂ per gram of H₂SO₄.
2 moles of HCl yields 1 mole H₂ (22.4 liters)
2 moles of HCl=73 grams

Therefore, a theoretical maximum yield of 0.31 liters of H₂ per gram of HCl is expected without the regeneration reaction.

The experiment setup was as illustrated in FIG. 2. The acid and iron solution was placed in flask 202. A hot plate 204 was used to provide thermal energy for the reaction and maintain the solution at a temperature of about 71° C. The gas produced by the reaction was fed through tube 206 to a volume-measuring apparatus 208. The volume-measuring apparatus 208 was an inverted container 210 filled with water and placed in a water bath 212. The primary purpose of the experiment was to provide evidence that more than the theoretical maximum 8.06 liters of hydrogen was being produced by the closed-loop process of the invention.

The rate of the reaction initially is very fast with hydrogen generation at ambient temperature. When the acids are temporally consumed, the regeneration process takes into effect and the reaction rate slows. Heat may be added to the process to accelerate the regeneration process.

At least 15 liters of gas was observed to have been produced, and the reaction was still proceeding in a continuous fashion (about 2 bubbles of gas per second at 71° C.) when interrupted. It should be noted that the 15 liters of gas observed does not account for hydrogen gas losses likely due to leakage. Based upon previous observations and theoretical projections, the first 8.06 liters of gas produced is likely to be made up of essentially pure hydrogen, and beyond the theoretical threshold of 8.06 liters, 66.7% by volume of the gas produced would be hydrogen and the other 33.3% by volume would be oxygen. It is believed this experiment provides ample evidence of the regeneration process.

A follow up experiment was conducted using iron (III) chloride (FeCl₃) as the only source of iron in an attempt to qualitatively verify the reverse reaction. Pure iron (III) chloride was chosen because it could be shown to be free of iron in any other oxidation state. While similar experiments had been successfully carried out using iron (III) oxide as the source of iron, the results were clouded by the fact that other oxidation states of iron may have been present. The results are described in Experiment 2, below.

Experiment #2:

An experiment was conducted using 150 mL of iron (III) chloride in an aqueous solution (commonly used as an etching solution, purchased from Radio Shack) as the starting materials. 10 mL of sulfuric acid (H₂SO₄) was added to the solution, at which point no reaction occurred. About 50 ml of colloidal magnesium and 80 ml of colloidal lead each at a concentration believed to be about 20 ppm was then added, at which point a chemical reaction began and the bubbling of gases was evident at ambient temperature. The production of gas accelerated when the solution was heated to a temperature of 150° F. The product gas was captured in soap bubbles and the bubbles were then ignited. The observed ignition of the gaseous product was typical for a mixture of hydrogen and oxygen.

Since the production of hydrogen gas could only be produced with a concurrent oxidation of iron, it is evident that the iron (III) had to be initially reduced before it could be oxidized, thereby providing strong evidence of the reverse reaction. This experiment has subsequently been repeated with hydrochloric acid (HCl) instead of sulfuric acid, with similar results.

Two additional follow up experiments (#3 using aluminum metal; and #4 using iron metal) were conducted to determine if more hydrogen is produced compared to the maximum amount expected solely from the consumption of the metal. These results are described below.

Experiment #3 Summary:

The starting solution included a total volume of 250 mL, including water, about 50 ml of colloidal magnesium and 80 ml of colloidal lead each at a concentration believed to be about 20 ppm, 10 mL of 93% concentration H₂SO₄ and 30 mL of 35% concentration HCl as in Experiment #1 above. Ten grams of aluminum metal were added to the solution which was heated and maintained at 90° C. The reaction ran for 1.5 hours and yielded 12 liters of gas. The pH measured under 2.0 at the end of 1.5 hours. The reaction was stopped after 1.5 hours by removing the unused metal and weighing it. The non-consumed aluminum weighed 4.5 grams, indicating a consumption of 5.5 grams of aluminum. The maximum amount of hydrogen gas normally expected by the net consumption of 5.5 grams of aluminum is 6.8 liters, as indicated in the table below.

Starting Solution Maximum H₂ Yield
With Aluminum Consumption

| | Total | | | |
|---|---|---|---|---|
| | Grams | Total | | |
| | Initial | Grams | Grams | Maximum |
| Metal | Supply | Final | Consumed | Yield* of H2 |
| Aluminum | 10 | 4.5 | 5.5 | 6.84 liters |
| (Al) | | | | |

* If reacted aluminum has exclusively been used for the production of hydrogen:
2 moles Al yields 3 moles H₂ (67.2 liters)
2 moles Al = 54 grams

Therefore, a theoretical maximum yield of 1.24 liters of H₂ per gram of Al is expected without the regeneration reaction described above.

As in Experiment #1, based on the total amount of acid supplied, it is expected that the first 8.06 liters of the gas generated is pure hydrogen with the balance being 50% hydrogen. Alternatively, the theoretical amount of hydrogen based on the amount of aluminum consumed is 6.84 liters. After 6.84 liters (the maximum yield expected from the aluminum consumed), it is expected that the remaining gas is 66.7% hydrogen. Therefore, we estimate that about 10.3 liters of hydrogen (out of about 12 total liters of gas) was produced in this experiment compared to the maximum of 6.84 or 8.06 liters expected based on the amount of aluminum consumed and the amount of acid supplied, respectively, thereby providing additional evidence of the regeneration process.

Experiment #4 Summary:

The starting solution included a total volume of 250 mL, including water, about 50 ml of colloidal magnesium and 80 ml of colloidal lead each at a concentration believed to be about 20 ppm, 10 mL of 93% concentration H₂SO₄ and 30 mL of 35% concentration HCl, as in Experiment #1 above. One hundred grams of iron pellets (sponge iron) were added to the solution, which was heated and maintained at 90° C. The reaction ran for 30 hours and yielded 15 liters of gas. The pH measured about 5.0 at the end of 30 hours. The reaction was stopped after 30 hours by removing the unused metal and weighing it. The non-consumed iron weighed 94 grams, indicating a consumption of 6 grams of iron. The maximum amount of hydrogen gas normally expected by the net consumption of 6 grams of iron, without the regeneration reaction described above, is 2.41 liters, as indicated in the table below.

Starting Solution Maximum H₂ Yield
With Iron Consumption

| | Total | | | |
|---|---|---|---|---|
| | Grams | Total | | Maximum |
| | Initial | Grams | Grams | Yield* |
| Metal | Supply | Final | Consumed | of H₂ |
| Iron (Fe) | 100 | 94 | 6 | 2.41 liters |

*If reacted iron has exclusively been used for the production of hydrogen:
1 mole Fe yields 1 mole H₂ (22.4 liters)
1 mole Fe = 55.85 grams

Therefore, a theoretical maximum yield of 0.40 liters of H₂ per gram of Fe is expected without the regeneration reaction described above.

As in Experiment #1, based on the total amount of acid supplied, it is expected that the first 8.06 liters of the gas generated is pure hydrogen with the balance being 66.7% hydrogen. However, the maximum theoretical generation of hydrogen based on the amount of iron consumed is 2.41 liters. After 2.41 liters (the maximum yield expected from the iron consumed), it is expected that the remaining gas is 33.3% hydrogen. Therefore, it is estimated that about 10.8 liters of hydrogen (out of about 15 total liters of gas) was produced in this experiment using colloidal catalyst; well over the maximum of 2.41 liters expected with the amount of iron consumed, thereby providing additional evidence of the regeneration process.

Experiment #5 Summary:

An Experiment was conducted using 200 mL of the final solution obtained from Experiment #4, which contained oxidized iron plus catalyst and was found to have a pH of 5. Acid was added to the solution, as in the above reactions (10 mL of 93% concentration H₂SO₄ and 30 mL of 35% concentration HCl), that brought the pH to a level of about 1. No additional colloidal materials were added, but 20 grams of aluminum metal was added. The solution was heated to a constant 96° C. The reaction proceeded to produce 32 liters of gas in a span of 18 hours, at which point the rate of the reaction had slowed significantly and the pH of the solution had become approximately 5.

The metal remaining at the end of the 18 hour experiment was separated and found to have a mass of 9 grams. This metal appeared to be a mixture of Al and Fe which came out of solution. Therefore, neglecting the amount of iron and aluminum remaining in solution, there was net consumption of 11 grams of metal and a net production of 32 liters of gas.

As indicated above, based on the amount of acid added to the reaction, the maximum amount of hydrogen gas expected solely from the reaction of acid with metal would be 8.06 liters. Depending on the makeup of the recovered metal which had a mass of 9 grams, two extremes are possible: a) assuming the metal recovered was 100% Al, a maximum of 13.75 liters of hydrogen gas would be expected from the consumption of 11 grams of aluminum; and b) alternatively, assuming the metal recovered was 100% Fe, a maximum of 21.25 liters of hydrogen gas would be expected from the consumption of 17 grams of aluminum (20 grams supplied minus three grams used in the production of iron). For purposes of calculating maximum hydrogen gas generation, we assume the regeneration process does not occur and the Fe metal would have been generated from a conventional single displacement reaction with Al.

The actual percentage of Al and Fe would be somewhere between the two extremes and, therefore, the maximum amount of hydrogen gas generated solely from the consumption of metal (without regeneration) would be between 13.75 liters and 21.25 liters. The observed generation of 32 liters of gas compared to the maximum amount one would expect from the sole consumption of metal indicates that the regeneration process is taking place. It is believed that the increase in the rate of H₂ production resulted from a high concentration of metal ions in the solution prior to the introduction of the elemental iron. Thus, resulting solutions from this family of reactions should not be discarded but rather should be used as the starting point for subsequent reactions. Consequently, this process for the generation of H₂ will not produce significant chemical wastes that need to be disposed of.

Experiment #6:

An experiment was conducted using 20 ml FeCl₃, 10 ml colloidal magnesium, and 20 ml colloidal lead at a temperature of about 90° C. A gas was produced which is believed to be a mixture of hydrogen and oxygen, based upon observing the ignition of the gas. The pH of the mixture decreased during the reaction from about 4.5 to about 3.5. These observations show that it is not necessary to introduce either metallic iron or acid into the solution to produce hydrogen. Since the electrochemical oxidation/reduction reactions (equations 25-28) result in the production of metallic iron and acid, these two constituents can be produced in this manner. Presumably, this would eventually reach the same steady state that is reached when metallic iron and acid are supplied initially.

The foregoing experiments were carried out under ambient lighting conditions which included a mixture of artificial and natural light sources. When the reactions described were performed under decreased light conditions the reaction rates decreased. However, separate formal testing under decreased lighting has not been performed.

It is believed the experimental results described above demonstrate the potential value of the inventions described herein. However, the results calculations are based on the theory of reaction mechanisms which are described above and which are believed to accurately characterize the reactions involved in these experiments. However, if it is discovered that the theories of reactions or the calculations based thereon are in error, the inventions described herein nevertheless are valid and valuable.

The embodiments shown and described above are exemplary. Many details are often found in the art and, therefore, many such details are neither shown nor described. It is not claimed that all of the details, parts, elements, or steps described and shown were invented herein. Even though numerous characteristics and advantages of the present inventions have been described in the drawings and accompanying text, the description is illustrative only, and changes may be made in the detail, especially in matters of shape, size, and arrangement of the parts within the principles of the inventions to the full extent indicated by the broad meaning of the terms of the attached claims.

The restrictive description and drawings of the specific examples above do not point out what an infringement of this patent would be, but are to provide at least one explanation of how to use and make the inventions. The limits of the inventions and the bounds of the patent protection are measured by and defined in the following claims.

1. An apparatus for the production of hydrogen, comprising:
a solution with a pH less than 7;
a first colloidal metal suspended in the solution; and
a non-colloidal metal.

2. The apparatus of claim 1, wherein the first colloidal metal is less reactive than the non-colloidal metal.

3. The apparatus of claim 1, wherein the first colloidal metal is more reactive than the non-colloidal metal.

4. The apparatus of claim 1 further comprising a second colloidal metal suspended in the solution.

5. The apparatus of claim 4, wherein the second colloidal metal is more reactive than the non-colloidal metal.

6. The apparatus of claim 1 further comprising a container for containing the solution, wherein the container is inert to the solution.

7. The apparatus of claim 1 wherein the first colloidal metal is silver, gold, platinum, tin, lead, copper, zinc, iron, aluminum, magnesium, beryllium, nickel or cadmium.

8. The apparatus of claim 1 wherein the non-colloidal metal is iron, aluminum, magnesium, beryllium, tin, lead, nickel or copper.

9. The apparatus of claim 1, further comprising an energy source.

10. The apparatus of claim 9, wherein the energy source is a heater.

11. The apparatus of claim 9, wherein the energy source is a light source.

12. The apparatus of claim 9, wherein the energy source is an electric potential applied between an anode and a cathode which are in electrical contact with the solution.

13. The apparatus of claim 1 further comprising an anode and a cathode, wherein the anode and cathode are in contact with the solution and wherein an electrical potential exists between the anode and cathode.

14. An apparatus for the production of hydrogen, comprising:
a solution containing an acid, wherein the acid is sulfuric acid, hydrochloric acid, hydrobromic acid, nitric acid, hydroiodic acid, perchloric acid or chloric acid;
a first colloidal metal suspended in the solution; and
a non-colloidal metal.

15. The apparatus of claim 14, wherein the first colloidal metal is less reactive than the non-colloidal metal.

16. The apparatus of claim 14, wherein the first colloidal metal is more reactive than the non-colloidal metal.

17. The apparatus of claim 14, further comprising a second colloidal metal suspended in the solution.

18. The apparatus of claim 17 wherein the second colloidal metal is more reactive than the non-colloidal metal.

19. The apparatus of claim 14 further comprising a container for containing the solution, wherein the container is inert to the solution.

20. The apparatus of claim 14, further comprising an energy source.

21. A method for the production of hydrogen, comprising the steps of:
suspending a first colloidal metal in a solution with a pH less than 7; and
introducing a non-colloidal metal into the suspension.

22. The method of claim 21 wherein the first colloidal metal is less reactive than the non-colloidal metal.

23. The method of claim 21 wherein the first colloidal metal is more reactive than the non-colloidal metal.

24. The method of claim 21 further comprising the step of introducing a second colloidal metal into the solution.

25. The method of claim 21 further comprising the step of supplying energy to the solution.

26. The method of claim 21 further comprising the step of producing oxygen gas.

27. The method of claim 21 further comprising both oxidation and reduction of the non-colloidal metal.

28. An apparatus for the production of hydrogen, comprising:
a solution with a pH less than 7;
a first metal at least partially submerged in the solution, the first metal having a surface area of at least 298,000,000 m² per cubic meter of first metal; and
a second metal at least partially submerged in the solution.

29. The apparatus of claim 28, wherein the second metal is more reactive than the first metal.

30. The apparatus of claim 28, wherein the second metal is less reactive than the first metal.

31. The apparatus of claim 28 further comprising a third metal, the third metal having a surface area of at least 298,000,000 m² per cubic meter of third metal.

32. An apparatus for the production of hydrogen, comprising:
a solution with a pH less than 7, wherein the solution contains cations of a metal; and
a first colloidal metal suspended in the solution.

33. The apparatus of claim 32, wherein the first colloidal metal is less reactive than the cation metal.

34. The apparatus of claim 32, wherein the first colloidal metal is more reactive than the cation metal.

35. The apparatus of claim 32, further comprising a second colloidal metal suspended in the solution.

36. The apparatus of claim 35, wherein the first colloidal metal is less reactive than the cation metal and wherein the second colloidal metal is more reactive than the cation metal.

37. The apparatus of claim 32, further comprising an energy source.

38. An apparatus for the production of hydrogen, comprising:
a solution with a pH less than 7;
a first colloidal metal suspended in the solution; and
an ionic metal.

39. The apparatus of claim 38, wherein the first colloidal metal is less reactive than the ionic metal.

40. The apparatus of claim 38, wherein the first colloidal metal is more reactive than the ionic metal.

41. The apparatus of claim 38 further comprising a second colloidal metal suspended in the solution.

42. The apparatus of claim 41, wherein the first colloidal metal is less reactive than the ionic metal and the second colloidal metal is more reactive than the ionic metal.

43. The apparatus of claim 38 further comprising a container for containing the solution, wherein the container is inert to the solution.

44. The apparatus of claim 38 wherein the first colloidal metal is silver, gold, platinum, tin, lead, copper, zinc, iron, aluminum, magnesium, beryllium, nickel or cadmium.

45. The apparatus of claim 41 wherein the second colloidal metal is aluminum, magnesium, beryllium or lithium.

46. The apparatus of claim 38 wherein the ionic metal is iron, aluminum, magnesium, beryllium, tin, lead, nickel or copper.

47. The apparatus of claim 38 further comprising an anode and a cathode, wherein the anode and cathode are in contact with the solution and wherein an electrical potential exists between the anode and cathode.

48. The apparatus of claim 38 further comprising a solid metal.

49. The apparatus of claim 38 further comprising an energy source.

50. A method for the production of hydrogen, comprising the steps of:
a.) suspending a first colloidal metal in a solution with a pH less than 7; and
b.) introducing an ionic metal into the suspension.

51. The method of claim 50 further comprising the step of reducing the ionic metal to produce a solid metal.
